(19) United States
(12) Patent Application Publication
(10) Pub. No.: US 2008/0187690 A1
(43) Pub. Date: Aug. 7, 2008

(54) Material Intended for Forming Images by Inkjet Printing

(76) Inventors: Stephanie V. Desrousseaux, Cambridge (GB); Olivier J. Poncelet, Chalon-Sur-Saone (FR); Joel C. Patarin, Flaxlanden (FR); Michel J. Souland, Mulhouse (FR)

Correspondence Address: EASTMAN KODAK COMPANY;PATENT LEGAL STAFF, 343 STATE STREET, ROCHESTER, NY, 14650-2201, US

(21) Appl. No.: 11/815,771

(22) PCT Filed: Feb. 2, 2006
(86) PCT No.: PCT/EP06/00900

§ 371 Date: Aug. 8, 2007

(30) Foreign Application Priority Data
Feb. 9, 2005 (FR) 0501277

(51) Int. Cl. B41M 5/50

(52) U.S. Cl. 428/32.21

(57) ABSTRACT

The present invention relates to a material intended for forming images by inkjet printing having good stability to ozone and to light. Said material comprises a support and at least one ink-receiving layer, said ink-receiving layer including particles of zeolite that has a pore system comprising at least ten oxygen atoms.

### FIELD OF THE INVENTIONS

The present invention relates to a material intended for forming images by inkjet printing.

### BACKGROUND OF THE INVENTION

Digital photography has been growing fast for several years; the general public now having access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.105 Pa) is forced through one or more nozzles so that the ink is transformed into a flow of droplets. In order to obtain the most regular possible sizes and spaces between drops, regular pressure pulses are sent using, for example, a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the ink jet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of the plates. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the base of inkjet printers used in office automation. With this method, the pressure in the ink cartridge is not maintained constant but is applied when a character has to be formed. In one widespread system there is a row of twelve open nozzles, each of them being activated with a piezoelectric crystal. The ink contained in the head is given a pulse: the piezo element contracts with an electric voltage, which causes a decrease of volume, leading to the expulsion of the drop by the nozzle. When the element resumes its initial shape, it pumps in the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of the obtained image. The printing paper must combine the following properties: high quality printed image, rapid drying during printing, good image colorfastness in time, and smooth and glossy appearance.

In general, the printing paper comprises a support coated with one or more layers according to the properties required. It is possible, for example, to apply on a support a primary attachment layer, an absorbent layer, an ink dye fixing layer and a protective layer or surface layer to provide the glossiness of the material. The absorbent layer absorbs the liquid part of the water-based ink composition after creation of the image. Elimination of the liquid reduces the risk of ink migration to the surface. The ink dye fixing layer prevents any dye loss into the fibers of the paper base to obtain good color saturation while preventing excess ink that would encourage the increase in size of the printing dots and reduce the image quality. The absorbent layer and fixing layer can also constitute a single ink-receiving layer ensuring both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boehmite. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispa™ (colloidal boehmite) marketed by Sasol. However, printing paper comprising an ink-receiving layer containing such inorganic receivers can have poor image stability in time, which is demonstrated by a loss of color density.

### SUMMARY OF THE INVENTION

To meet the new requirements of the market in terms of photographic quality, printing speed and color stability, it is necessary to offer a new material intended for inkjet printing having the properties as defined above and more particularly good stability of the colors of the printed image to ozone and to light, meaning good colorfastness of the image over time.

Therefore, the new material according to the present invention, intended for forming images by inkjet printing, comprises a support and at least one ink-receiving layer, and is characterized in that it comprises particles of zeolite that has a pore system comprising at least ten oxygen atoms.

Preferably, the zeolite has a pore system with ten oxygen atoms, such as zeolite with MFI structure, or with twelve oxygen atoms, such as zeolite with *BEA structure.

The use of such zeolite particles in a material intended for forming images by inkjet printing enables a printed image to be obtained having improved stability, and in particular improved color stability of the printed image to ozone and to light.

Other characteristics will appear on reading the following description, with reference to the drawings.

### BRIEF DESCRIPTION OF THE DRAWINGS

FIGS. 1 and 2 represent the percentage of color density loss for various comparative materials and according to the present invention exposed to ozone, and

FIG. 3 represents the percentage of color density loss for various comparative materials and according to the present invention when exposed to light.

### DETAILED DESCRIPTION OF THE INVENTION

The material intended for forming images by inkjet printing according to the present invention comprises firstly a support. This support is selected according to the desired use. It can for example be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and mixtures thereof. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute a material intended for inkjet printing. The side of the support that is used can be coated with a very thin layer of gelatin or another composition to ensure the adhesion of the first layer on the support. To improve the adhesion of the ink-receiving layer on the support, the support surface can also have been subjected to a preliminary treatment by Corona discharge before applying the ink-receiving layer.

The material according to the invention comprises at least one ink-receiving layer comprising at least one hydrosoluble binder. Said hydrosoluble binder can be a hydrophilic polymer such as poly(vinyl alcohol), poly(vinyl pyrrolidone), gelatin, cellulose ethers, poly(oxazolines), poly(vinylacetamides), poly(vinyl acetate/vinyl alcohol) partially hydrolyzed, poly(acrylic acid), poly(acrylamide), sulfonated or phosphated polyesters and polystyrenes, casein, zein, albumin, chitin, dextran, pectin, derivatives of collagen, agar-agar, guar, carragheenane, tragacanth, xanthan and others. In preference, gelatin or poly(vinyl alcohol) are used. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the poly(vinyl alcohol) from Nippon Gohsei, or Air Product under the name Airvol® 130.

The material according to the present invention also comprises particles of zeolite that has a pore system comprising at least ten oxygen atoms. According to a preferred embodiment, the zeolite particles are put into the ink receiving layer and are used as inorganic receivers.

Zeolites are porous crystalline materials. Structurally, a zeolite is an assembly of crystallized aluminosilicate cages. The unit cage consists of an assembly of tetrahedrons combining complexes of aluminum oxide and silicon oxides, and sharing oxygen atoms. Therefore, a zeolite is characterized by an assembly of tetrahedrons QO₄, where Q generally represents Si and Al atoms, but also Ti, Ge, B, Fe and Ga. The anionic charges are balanced by the presence of alkaline or alkaline-earth cations (Na, K, Li, Ca) and are finally organized according to the formula M_{x/n}[AlₓSi_{y}O_{2(x+y)}], zH₂O. According to the value of the y/x ratio, the structures can be classified into several types. More than 120 types of elementary structure have been found and classified according to a three-letter code by the International Zeolite Association. The meaning of these codes is, for example, described in the atlas of zeolite structures: Ch. Baerlocher, W. W. Meier, D. H. Olson, Atlas of zeolite framework types, Fifth revised Edition, Elsevier, Amsterdam 2001, 3-18. Synthesis of zeolites is described, for example, in the publications, H. Kessler, Synthesis of Molecular Sieves, Comprehensive Supramolecular Chemistry, G. Alberti, T. Bein (Eds.), Vol. 7, Pergamon, Oxford, 1996, 425-464, and C. S. Cundy and P. A. Cox, The Hydrothermal Synthesis of Zeolites: History and Development from the Earliest Days to the Present Time, Chem. Rev. 2003, 103, 663-701. U.S. Pat. Nos. 4,061,724 and 4,073,865 describe the synthesis processes of a zeolite with MFI structure, with y/x molar ratio equal to ∞, called silicalite. Hereafter, this material will be called Silicalite-1. Patent Application WO 97/33830 describes a synthesis process of a zeolite with *BEA structure.

The pore system of these porous crystalline materials can be described advantageously by the number of oxygen atoms that make up the pores. For perfectly cylindrical pores, there is a good relationship between the number of pore oxygen atoms and their diameter. Thus, for example a pore bounded by twelve oxygen atoms corresponds to a diameter of 0.74 nm.

According to one embodiment of the present invention, the zeolite has a pore system with ten oxygen atoms, like zeolite with MFI or MEL structure. Preferably, a zeolite with MFI structure is used. When the Si/Al molar ratio equals ∞, a zeolite comprising 100 percent Si, called silicalite-1 is obtained.

Zeolites of MFI structural type containing aluminum next to silicon in their mineral framework are called ZSM-5. Preferably, the SiO₂/Al₂O₃ molar ratio of zeolite ZSM-5 varies between 5 and 100, preferably between 10 and 85, and preferably between 10 and 60. The SiO₂/Al₂O₃ molar ratio of zeolite ZSM-5 can also vary between 100 and infinity.

According to another embodiment of the present invention, the zeolite has a pore system with twelve oxygen atoms, like zeolite with *BEA or FAU structure. Preferably, a zeolite with *BEA structure is used. When the Si/Al molar ratio equals ∞, a zeolite comprising 100 percent Si is obtained. In all these cases, the zeolite is called Beta.

Generally, any zeolitic material whose pore system is bounded by at least ten oxygen atoms is a good material for the ink-receiving layer. We can mention non-exhaustively and as examples zeolites of structural type TON, MTT, and MEL. Preferably, from among these zeolites, those having a high Si/Al molar ratio (Si/Al>5) and having a hydrophobic character can be selected.

The ink-receiving layer has between 5 percent and 95 percent by weight of zeolite particles compared with the total weight of the ink-receiving layer in the dry state. The zeolite particles can be combined with other inorganic receivers, such as silicas, boehmites, other aluminosilicates, etc.

The composition of the coating intended to form the ink-receiving layer is produced by mixing the hydrosoluble binder and the zeolite particles. The composition can also comprise a surfactant to improve its coating properties. The composition can be layered on the support according to any appropriate coating method, such as blade, knife or curtain coating. The composition is applied with a thickness between approximately 100 μm and 300 μm in the wet state. The composition forming the ink-receiving layer can be applied to both sides of the support. It is also possible to provide an antistatic or anti-winding layer on the back of the support coated with the ink-receiving layer.

The material intended for forming images by inkjet printing according to the invention can comprise, besides the ink-receiving layer described above, other layers having another function, arranged above or below said ink-receiving layer. The ink-receiving layer as well as the other layers can comprise all the other additives known to those skilled in the art to improve the properties of the resulting image, such as UV ray absorbers, optical brightening agents, antioxidants, plasticizers, etc.

The material intended for forming inkjet printing images according to the invention enables a printed image having improved color stability to ozone and to light to be obtained. It can be used for any type of inkjet printer as well as for all the inks developed for this technology.

The following examples illustrate the present invention without however limiting the scope.

3) Preparation of Zeolite Particles

### Synthesis 1

Material 1 was silicalite-1, prepared by using the fluoride ion as mineralizing agent and tetrapropylammonium bromide (TPABr) as structuring agent, according to a synthesis protocol similar to that described in U.S. Pat. No. 4,073,865.

The stoichiometric proportions of the reagents were the following:

1SiO₂: 0.1 TPABr: 0.5 NH₄F: 20 H₂O.
4.625 g ammonium fluoride (Prolabo) and 6.65 g TPABr (Fluka) were dissolved in 90 ml deionized water. This solution was then added to 15 g silica (Aerosil®200, Degussa) and homogenized using a spatula. A white paste was obtained in 30 minutes at room temperature. The curing then lasted two hours at room temperature. Crystallization took place under autogenous pressure at 200° C., for 3.5 days, without stirring and without germ addition.

The resulting precipitate was filtered to eliminate the supernatant and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 550° C. in three hours, step at 550° C. for five hours, then return to room temperature.

Observation by scanning electron microscope (Philips XL30) showed prismatic crystals with even distribution, with dimensions 100×25×20 μm³.

X-ray diffraction analysis (Philips PW1800 diffractometer using Cu Kα radiation at 35 kV and 55 mA in 2θ angular field from 1° to 50° by steps of 0.01° with count time of 1 s) indicated a monoclinic prism for the calcinated form, characteristic of silicalite-1, with MFI structural type.

### Synthesis 2

Material 2 was silicalite-1, prepared by using the hydroxyl ion as mineralizing agent and tetrapropylammonium bromide (TPABr) as structuring agent, according to a synthesis protocol similar to that described in U.S. Pat. No. 4,061,724.

The stoichiometric proportions of the reagents were the following:

1SiO₂: 0.1 TPABr: 0.2 NaOH: 20 H₂O.

2 g NaOH (SDS) and 6.65 g TPABr (Fluka) were dissolved in 90 ml deionized water. This solution was then added to 15 g silica (Aerosil®200, Degussa) and homogenized using a spatula. A white paste was obtained in 30 minutes at room temperature. The curing then lasted one hour at room temperature. Crystallization took place under autogenous pressure at 200° C., for one day, without stirring and without germ addition.

The resulting precipitate was filtered to eliminate the supernatant and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 550° C. in three hours, step at 550° C. for five hours, then return to room temperature.

Observation by scanning electron microscope (Philips XL30) showed twinned crystals with even distribution, with average dimensions 10×10×10 μm³.

X-ray diffraction analysis, under the same conditions as for synthesis 1, indicated a monoclinic prism for the calcinated form, characteristic of silicalite-1, with MI structural type.

### Synthesis 3

Material 3 was zeolite with MFI structure, with Si/Al molar ratio=100, prepared by using the fluoride ion as mineralizing agent and tetrapropylammonium bromide (TPABr) as structuring agent, according to a synthesis protocol similar to that described in U.S. Pat. No. 4,073,865.

The stoichiometric proportions of the reagents were the following:

1SiO₂: 0.1 TPABr: 1 NH₄F: 0.065AlF₃: 8 H₂O.

9.25 g ammonium fluoride (Prolabo) and 6.65 g TPABr (Fluka) were dissolved in 36 ml deionized water. This solution was then added to 15 g silica (Aerosil®200, Degussa) and to 2.24 g AlF₃,3H₂O (Fluka) and homogenized using a spatula. A white paste was obtained in 30 minutes at room temperature. Crystallization took place under autogenous pressure at 200° C., for 2 days, without stirring and without germ addition.

The resulting precipitate was filtered to eliminate the supernatant and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 550° C. in three hours, step at 550° C. for five hours, then return to room temperature.

Observation by scanning electron microscope (Philips XL30) showed elongated parallelepiped crystals, with dimensions 120×25×20 μm³.

X-ray diffraction analysis under the conditions of synthesis 1 indicated a monoclinic prism for the calcinated form, characteristic of the MFI structural type, but which also had a preferred orientation phenomenon.

Elementary analysis of the zeolite crystals of this sample led to an Si/Al molar ratio close to 100.

### Synthesis 4

Material 4 was ZSM-5 zeolite with MFI structure, with Si/Al molar ratio=13, prepared by using the hydroxyl ion as mineralizing agent and tetrapropylammonium bromide (TPABr) as structuring agent, according to a synthesis protocol similar to that described in U.S. Pat. No. 3,702,886.

The stoichiometric proportions of the reagents were the following:

1SiO₂: 0.1 TPABr: 0.2 NaOH: 0.07 NaAlO₂: 20 H₂O.

2 g NaOH (SDS) and 6.65 g TPABr (Fluka) were dissolved in 90 ml deionized water. This solution was then added to 15 g silica (Aerosil®200, Degussa) and to 1.44 g sodium aluminate (NaAlO₂) and homogenized using a spatula. A white paste was obtained in 30 minutes at room temperature. Crystallization took place under autogenous pressure at 200° C., for one day, without stirring and without germ addition.

The resulting precipitate was filtered to eliminate the supernatant and then rinsed three times with 100 ml of deionized water. The precipitate was then dried at 90° C. for one hour. A white powder was obtained.

The structuring agent was elininated by calcination in air according to the following temperature program: rise to 200° C. in less than one hour, step at 200° C. for one hour, rise to 550° C. in three hours, step at 550° C. for five hours, then return to room temperature.

Observation by scanning electron microscope (Philips XL30) showed almost spherical crystals, with diameter 8 μm.

X-ray diffraction analysis under the conditions of synthesis 1 indicated a orthorhombic prism for the calcinated form, characteristic of the MFI structural type with low Si/Al ratio. Elementary analysis of the zeolite crystals of this sample led to an Si/Al molar ratio=13.

### Synthesis 5

Material 5 was a silicalite-1, with small crystals, prepared by using the hydroxyl ion as mineralizing agent and tetrapropylammonium hydroxide (TPAOH) as structuring agent. The stoichiometric proportions of the reagents were the following:

1SiO₂: 0.12 TPAOH: 0.008 Na₂O: 19.2 H₂O: 4 EtOH.

The operating method followed the procedure described by A. E. Persson, B. J. Schoeman, J. Sterte, J. E. Otterstedt, The synthesis of discrete colloidal particles of TPA-silicalite-1, Zeolites, 1994, vol. 14, 557-567.

In a seasoned polypropylene flask, 15.6 g of tetraethoxysilane (Aldrich) were mixed in 25.9 g osmosed water and then stirred at room temperature for 20 hours. 24 mg of NaOH (SDS) were dissolved in 9.1 g of a 1M solution of TPAOH (Aldrich). This solution was added to the reaction mixture with vigorous stirring. The reaction mixture was then heated to reflux to 98° C. without stirring during 72 hours. A white opaque solution was obtained. Purification was carried out by dialysis in osmosed water (Roth Nadir membrane, catalogue reference 5104.1) during 48 hours. The purified solution was lyophilized. A white powder was obtained.

The structuring agent was eliminated by calcination in air at 600° C. for 30 min. Observation by scanning electron microscope (Philips XL30 Sfeg) showed rounded crystals, with diameter between 300 nm and 600 nm.

X-ray diffraction analysis (INEL CPS120, Cu anticathode) showed a monoclinic prism for the calcinated form, characteristic of the MFI structural type.

### Synthesis 6

Material 6 was a commercial zeolite with MFT structure, marketed by Aldrich with the reference 41,909-5. It contained mostly silicon, traces of aluminum and sodium. X-ray diffraction analysis (Philips PW 1800 diffractometer in the conditions of synthesis 1) indicated a monoclinic prism, characteristic of silicalite-1, with MFI structural type. Observation by scanning electron microscope (Philips XL30 Sfeg) showed parallelepiped crystals, more or less twinned, with even size distribution ranging from 1 μm to 5 μm.

### Synthesis 7

Material 7 was purely silica beta zeolite with *BEA structure, prepared by using the fluoride ion as mineralizing agent and the tetraethylammonium cation (TEA) as structuring agent, according to a synthesis protocol similar to that described in Patent Application WO 97/33830.

The composition of the reaction medium was the following:

1SiO₂: 0.7 TEAOH: 0.7 HF: 10 H₂O.

25.7 g of TEAOH solution at 40 percent (Aldrich) were put in a polypropylene beaker, to which were added 20.8 g of tetraethylorthosilicate (TEOS, Fluka). The mixture was stirred at room temperature and the ethanol formed during the TEOS hydrolysis was allowed to completely evaporate, i.e. when the weight reached 28.4 g, before adding 3.5 g HF at 40% (Carlo Erba). Then fast polymerization of the silica was observed which was shown by a formation of gel blocks. This finely crushed reaction gel underwent curing for one hour at room temperature before being put into an autoclave having a PTFE jacket. Crystallization took place at 150° C. for six days at autogenous pressure.

The resulting precipitate was filtered to eliminate the supernatant, and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 500° C. in three hours, step at 500° C. for five hours, then return to room temperature.

Observation by scanning electron microscope (Philips XL30) showed crystals in the shape of systematically truncated square-based dipyramids, with even distribution: the height was close to 12 μm and the width about 8 μm. They were not single crystals because the truncated tops of the dipyramids did not have a smooth surface, but were constituted by mosaics of smaller crystals from 100 nm to 200 nm.

The x-ray diffraction pattern (in the conditions of synthesis 1) showed a series of wide lines and fine lines characteristic of beta zeolite.

### Synthesis 8

Material 8 was purely silica beta zeolite with *BEA structure, prepared in the presence of germs by using the fluoride ion as mineralizing agent and the tetraethylammonium cation (TEA⁺) as structuring agent, according to a synthesis protocol similar to that described in Patent Application WO 97/33830.

The composition of the reaction medium was the following:

1SiO₂: 0.7 TEAOH: 0.7 HF: −10 H₂O.

25.7 g of TEAOH solution at 40 percent (Aldrich) were put in a polypropylene beaker, to which were added 20.8 g of TEOS (Fluka). The mixture was stirred at room temperature and the ethanol formed during the hydrolysis of the TEOS was allowed to evaporate completely. When the weight reached 28.4 g, 0.1 g of germs were introduced of crushed crystals coming from the beta zeolite obtained previously according to synthesis 7, then 3.5 g of HF at 40 percent (Carlo Erba) were added. Then fast polymerization of the silica took place with the formation of gel blocks. After curing for one hour at room temperature, this finely crushed reaction gel was put into a polypropylene flask tightly closed by a plug to prevent any evaporation. Crystallization took place in moderate conditions at 90° C. for thirty days.

The resulting precipitate was filtered to eliminate the supernatant and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 500° C. in three hours, step at 500° C. for five hours, then return to room temperature.

Using a scanning electron microscope (Philips XL30), small (10 μm to 15 μm) or larger (20 μm to 50 μm) agglomerates of crystals with size varying from 0.5 μm to 5 μm were observed.

The x-ray diffraction pattern (Philips PW1800 diffractometer in the conditions of synthesis 1) was characteristic of beta zeolite.

### Synthesis 9

Material 9 was purely silica beta zeolite with *BEA structure, prepared in fluoride medium with a source of pyrogenic silica and in the presence of germs. In this example, material 9 was prepared in economic conditions by considerably reducing the amounts of structuring and mineralizing agents, by using a source of pyrogenic silica less costly than TEOS and which did not entail alcohol release. In this case, the stoichiometric proportions of the reaction mixture were the following:

1SiO₂: 0.3 TEAOH: 0.3 HF: 5 H₂O.

13.25 g of TEAOH solution at 40 percent (Aldrich) was put in a beaker, to which were added 1.8 g deionized water and 0.1 g of germs of crushed crystals coming from the beta zeolite obtained according to synthesis 7. The solution was poured into a polypropylene beaker containing 7.2 g silica (Aerosil®200 Degussa). The mixture was well homogenized and led to a very viscous gel and then 1.8 g HF at 40 percent (Carlo Erba) were added. The whole was again well mixed to give a reaction gel having the appearance of a paste, which underwent curing for one hour at room temperature before being put into an autoclave having a PTFE jacket. Crystallization took place at 120° C. for one and a half days at autogenous pressure. The resulting precipitate was filtered to eliminate the supernatant and then rinsed three times with 100 ml of deionized water. The precipitate was then dried at 90° C. for one hour. A white powder was obtained.

The structuring agent was eliminated by calcination in air according to the following temperature program: rise to 200° C. in less than one hour, step at 200° C. for one hour, rise to 500° C. in three hours, step at 500° C. for five hours, then return to room temperature.

Using a scanning electron microscope (Philips XL30), agglomerates were observed of about 10 μm to 50 μm, formed of crystals of dipyramid shape and even dimensions (4-5 μm) whose surface was partly covered by small particles. The x-ray diffraction pattern (Philips PW1800 diffractometer in the conditions of synthesis 1) was characteristic of beta zeolite.

### Synthesis 10

Material 10 was an aluminosilicate beta zeolite with *BEA structure, prepared by using the hydroxyl anion as mineralizing medium and the tetraethylammonium cation (TEA⁺) linked to the Na⁺ cation as structuring agents, according to the adapted synthesis process of that described in the publication, M. A. Camblor, A. Mifsud, J. Pérez-Pariente, Influence of the synthesis conditions on the crystallization of Zeolite Bêta, Zeolites, 1991, 11, 792-797.

In this case, the stoichiometric proportions of the reaction mixture were the following:

1 SiO₂: 0.5 TEAOH: 0.02 NaAlO₂: 0.08 NaOH: 15 H₂O.

Into a first beaker, 45.94 g of TEAOH solution at 40 percent (Aldrich), then 15.0 g silica (Aerosil®200 Degussa) were put and half the quantity of deionized water, i.e. 24.56 g. Into a second beaker, 3.2 g of soda as pellets (SDS) and 1.64 g sodium aluminate (Strem) were dissolved in the other half of the quantity of deionized water, i.e. 24.56 g. This solution was poured into the first beaker and after homogenization, a relatively fluid gel was obtained. After curing for one hour at room temperature, the reaction mixture was transferred into a PTFE jacketed autoclave and then raised to 150° C. for six days. After reaction, the resulting precipitate, formed by very small particles, could not be separated from the supernatant by filtration, but the solid could be isolated by centrifugation. Also, the solid phase was separated from the mixture by rotation at 9000 rpm using a centrifuge (Beckman Coulter, type Avanti J-301). The filtrate was eliminated and the solid taken with 50 ml of deionized water, to be centrifuged again and the operation was repeated three times. Thus, the excess reagents, especially the silica in solution, could be completely eliminated. The dry powder was obtained by lyophilization (Cryo Rivoire device).

The structuring agent was eliminated by calcination in air according to the following temperature program: rise to 200° C. in less than one hour, step at 200° C. for one hour, rise to 500° C. in three hours, step at 500° C. for five hours, then return to room temperature.

Using a scanning electron microscope (Philips XL30), agglomerates of very small crystals with dimensions less than 200 nm were observed.

The x-ray diffraction pattern (Philips PW1800 diffractometer in the conditions of synthesis 1) was in conformity with that of beta zeolite. Chemical analysis of the aluminum and silicon, performed by ICP-AES (Vista Axial Varian) on the product after calcination, indicates an Si/Al ratio˜21.

2) Preparing Compositions Intended to be Layered on a Support to Constitute an Ink-receiving Layer

The compositions comprise as receiving agent the zeolite particles prepared according to syntheses 1 to 10 of paragraph 1.

For comparison, the following materials were used:
Material 11: commercial zeolite 3A with LTA structure
Material 12: commercial zeolite 4A with LTA structure
Material 13: Commercial amorphous colloidal silica Ondeo Nalco®2329 (40 percent), marketed by Ondeo Nalco Corporation.

Material 11 is marketed by Aldrich with reference number 23,364-1. It contains mostly silicon, aluminum and potassium with Si/Al molar ratio close to 1 (determined by ICP-AES, Vista Axial Varian). X-ray diffraction analysis (Philips PW 1800 diffiactometer in the conditions of synthesis 1) indicated a cubic prism, characteristic of the LTA structure, for which zeolite has a pore system with eight oxygen atoms.

Observation by scanning electron microscope (Philips XL30 Sfeg) showed agglomerates of cubic crystals from 2 μm to 3 μm.

Material 12 is marketed by Aldrich with reference number 23,366-8. It contains mostly silicon, aluminum and sodium with Si/Al molar ratio close to 1 (determined by ICP-AES, Vista Axial Varian). X-ray diffraction analysis (Philips PW 1800 diffractometer in the conditions of synthesis 1) indicated a cubic prism, characteristic of the LTA structure, for which zeolite has a pore system with eight oxygen atoms.

Observation by scanning electron microscope (Philips XL30 Sfeg) showed agglomerates of cubic crystals from 2 μm to 3 μm.

As hydrosoluble binder, poly(vinyl alcohol) is used (Gohsenol™ GH23 marketed by Nippon Gohsei) diluted to nine percent by weight in osmosed water.

All the layering compositions are prepared from an aqueous formula containing 13.5 percent of the material 1 to 13, 1.6 percent of binder and osmosed water. The mixtures were homogenized by shearing overnight.

3) Preparing Materials Intended for Forming Images by Inkjet Printing

To do this, a Resin Coated Paper type support was placed on a coating machine, first coated with a very thin gelatin layer, and held on the coating machine by vacuum. This support was coated with a composition as prepared according to section 2 using a blade means with a wet thickness of 200 μm. Then, it was left to dry for three hours at ambient air temperature (21° C.).

The resulting materials corresponded to the examples shown in Table I below giving the receiving agent used in the ink-receiving layer:

TABLE I

| Material | Receiving agent in the ink-receiving layer |
|---|---|
| Ex 1 (inv.) | Material 1, MFI zeolite |
| Ex 2 (inv.)² | Material 2, MFI zeolite |
| Ex 3 (inv.) | Material 3, MFI zeolite |
| Ex 4 (inv.) | Material 4, MFI zeolite |
| Ex 5 (inv.) | Material 5, MFI zeolite |
| Ex 6 (inv.) | Material 6, MFI zeolite |
| Ex 7 (inv.) | Material 7, *BEA zeolite |
| Ex 8 (inv.) | Material 8, *BEA zeolite |
| Ex 9 (inv.) | Material 9, *BEA zeolite |
| Ex 10 (inv.) | Material 10, *BEA zeolite |
| Ex 11 (comp.) | Material 11, LTA zeolite |
| Ex 12 (comp.) | Material 12, LTA zeolite |
| Ex 13 (comp.) | Material 13, silica |

4) Evaluating Colorfastness Over Time

To evaluate colorfastness over time, a color alteration test by exposure to ozone was performed for each resulting material. To do this, test charts, comprising four colors, black (K), yellow (Y), cyan (C) and magenta (M) were printed on each material using a KODAK PPM 200 or an Epson 890 printer and the related ink. The test charts were analyzed using a GietagMacbeth Spectrolino densitometer that measures the intensity of the various colors. Then the materials were placed in the dark in a room with controlled ozone atmosphere (60 ppb) for three weeks. Each week, any degradation of the color density was monitored using the densitometer. If the density loss was lower than 30 percent at the end of three weeks, the ink-receiving material was considered as enabling a printed image to be formed that is particularly stable in the presence of ozone.

Also, for the resulting materials, a color alteration test was carried out by exposure to light of 50 Klux for two weeks. To do this, test charts, comprising four colors, black (K), yellow (Y), cyan (C) and magenta (M) were printed on the resulting materials using an Epson 890 printer and the related ink. Then the printed test charts were placed under a sheet of Plexiglas® 6 mm thick and totally transparent to the emission spectra of the neon tubes used (Osram Lumilux® FQ 80 W/840 Cool White), in order to minimize atmospheric oxidation phenomena. Any deterioration of the color density was measured using the densitometer after two weeks. If the density loss was less than 30 percent at the end of two weeks, the ink-receiving material was considered as enabling a printed image to be formed that is particularly stable to light.

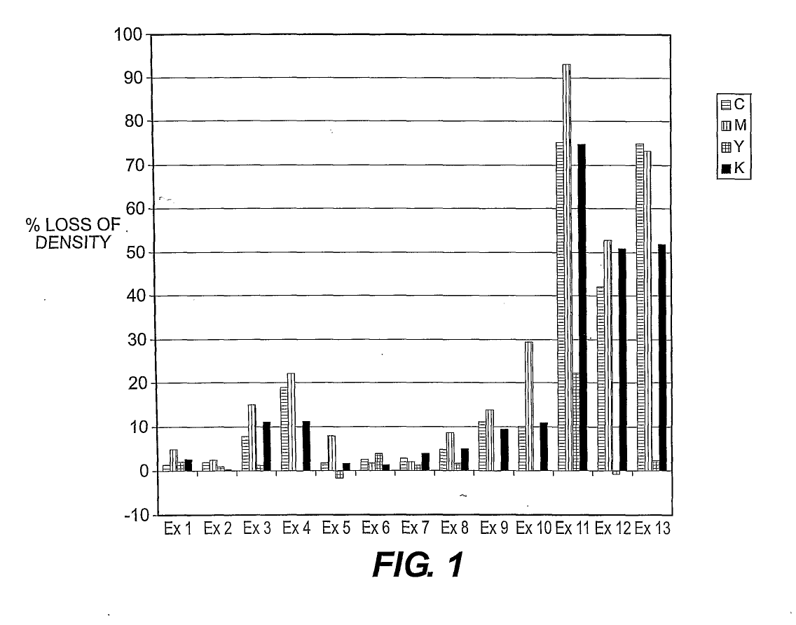

FIG. 1 represents the percentage of density loss observed for the density of 1 for the four colors of the test chart after three weeks for examples 1 to 13 printed using the Kodak PPM 200 printer and exposed to ozone. Letters K, C, M and Y represent the colors black, cyan, magenta and yellow respectively.

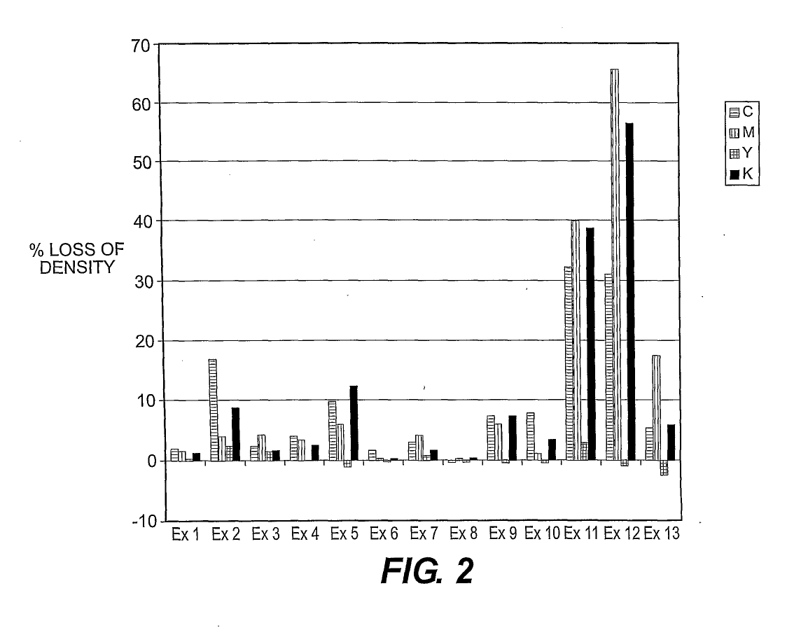

FIG. 2 represents the percentage of density loss observed for the density of 1 for the four colors of the test chart after three weeks for examples 1 to 13 printed using the Epson 890 printer and exposed to ozone.

It may be noticed that the materials according to the invention (Examples 1 to 10) comprising zeolite particles with MFI and *BEA structure, having a pore system with ten and twelve oxygen atoms respectively, have greater stability to ozone and thus better colorfastness than the comparative materials comprising a zeolite with LTA structure, having a pore system with eight oxygen atoms (Examples 11 and 12) or a silica (Example 13).

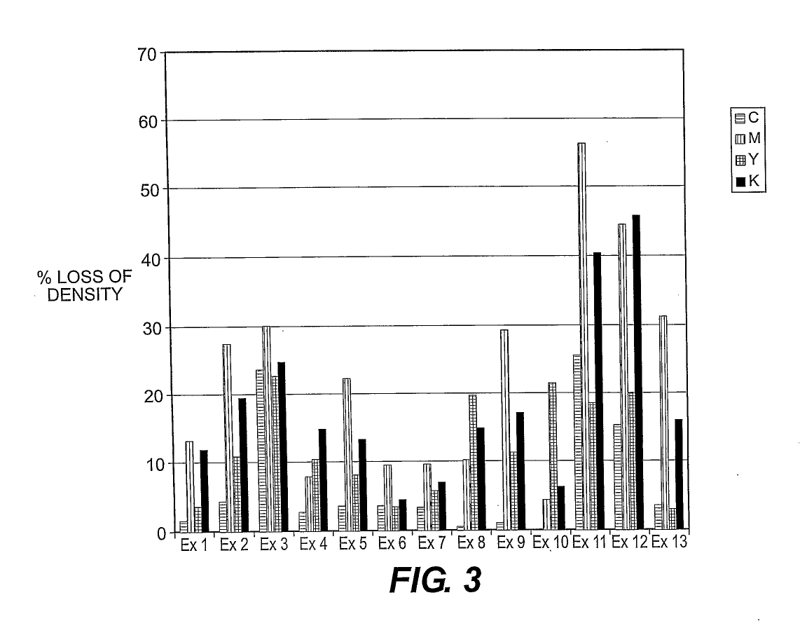

FIG. 3 represents the percentage of density loss observed for the density of 1 for the four colors of the test chart after two weeks for examples 1 to 13 printed using the Epson 890 printer and exposed to light.

It may be noticed that the materials according to the invention (Examples 1 to 10) comprising zeolite particles with MFI and *BEA structure, having a pore system with ten and twelve oxygen atoms respectively, have greater stability to light and thus better colorfastness than the comparative materials comprising a zeolite with LTA structure, having a pore system with eight oxygen atoms (Examples 11 and 12) or a silica (Example 13).

1. A material intended for forming images by inkjet printing, comprising a support and at least one ink-receiving layer, characterized in that it comprises particles of zeolite that has a pore system comprising at least ten oxygen atoms.

2. A material according to claim 1, characterized in that the zeolite has a pore system with ten oxygen atoms.

3. A material according to claim 2, characterized in that the zeolite is a zeolite with MFI structure.

4. A material according to claim 3, characterized in that the zeolite is a ZSM-5 zeolite.

5. A material according to claim 4, characterized in that the SiO₂/Al₂O₃ molar ratio is between 5 and 100.

6. A material according to claim 4, characterized in that the SiO₂/Al₂O₃ molar ratio is greater than 100.

7. A material according to claim 3, characterized in that the zeolite is silicalite with Si/Al ratio equal to ∞.

8. A material according to claim 1, characterized in that the zeolite has a pore system with twelve oxygen atoms.

9. A material according to claim 8, characterized in that the zeolite is a zeolite with *BEA structure.

10. A material according to claim 9, characterized in that the zeolite is a beta zeolite.

11. A material according to claim 9, characterized in that the Al/Si molar ratio is between 8 and ∞.

12. A material according to claim 1, characterized in that the zeolite particles are put into the ink-receiving layer.

13. A material according to claim 12, characterized in that the ink-receiving layer comprises between 5 percent and 95 percent by weight of zeolite particles compared with the total weight of the dry receiving layer.

14. A material according to claim 1, characterized in that the ink-receiving layer comprises a hydrosoluble binder.

15. A material according to claim 14, characterized in that the hydrosoluble binder is gelatin or poly(vinyl alcohol).

16. The use of zeolite particles having a pore system comprising at least ten oxygen atoms in a material intended for forming images by inkjet printing, comprising a support and at least one ink-receiving layer to improve the stability of the image printed on said material.
